(19) United States
(12) Patent Application Publication
(10) Pub. No.: US 2019/0147498 A1
(43) Pub. Date: May 16, 2019

(54) INCREASING FILL RATE WHILE MAINTAINING AVERAGE MARGIN

(71) Applicant: Google Inc., Mountain View, CA (US)

(72) Inventors: James Giles, Yorktown Heights, NY (US); Wei-Hao Lin, New York, NY (US)

(21) Appl. No.: 14/676,065

(22) Filed: Apr. 1, 2015

(51) Int. Cl. G06Q 30/02

(52) U.S. Cl. CPC G06Q 30/0275

(57) ABSTRACT

Methods, systems, and apparatus include computer programs encoded on a computer-readable storage medium, including a method for increasing fill rate while maintaining average margin for a content serving system. Web properties associated with a publisher are identified, each web property including slots for inclusion of third party content, each slot having a reserve price which represents a minimum amount the publisher will accept for inclusion of the third party content in the slot when presented to viewers. Over a time period, an average margin is maintained for a serving system for the publisher. Bids that are valued at a price that is less than the reserve price plus a margin for the serving system are subsidized using a surplus account, based on accepted winning bids that are valued at a price that exceeds a sum of the reserve price plus compensation for the serving system.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented.

### SUMMARY

In general, one innovative aspect of the subject matter described in this specification can be implemented in methods that include a computer-implemented method for increasing fill rate while maintaining average margin for a content serving system. The method includes identifying one or more web properties associated with a publisher, each web property including one or more slots for inclusion of third party content. Each slot has a reserve price which represents a minimum amount the publisher will accept for inclusion of the third party content in the slot when presented to viewers. The method further includes determining the reserve price for a given slot. The method further includes, over a time period, maintaining an average margin that is to be associated with a serving system for the publisher, including accepting and subsidizing bids that are valued at a price that is less than the reserve price by subsidizing low winning bids using a surplus that is accumulated in or predicted for the time period, based on accepted winning bids that are valued at a price that exceeds a sum of the reserve price plus compensation for the serving system.

In general, another innovative aspect of the subject matter described in this specification can be implemented in methods that include another computer-implemented method for increasing fill rate while maintaining average margin for a content serving system. The method includes identifying one or more web properties associated with a publisher, each web property including one or more slots for inclusion of third party content. Each slot has a reserve price which represents a minimum amount the publisher will accept for inclusion of the third party content in the slot when presented to viewers. The method further includes determining the reserve price for each slot associated with the one or more web properties. The method further includes determining a margin that is to be associated with a serving system, the margin being a portion that is paid to the serving system from a winning bid associated with an auction that is conducted. The method further includes creating a surplus account to be associated with a time period for the publisher, and initiating the surplus account. The method further includes evaluating current bids for slots on the one or more web properties, including accepting winning bids that are valued at a price that is greater than a combination of the reserve price plus the margin including crediting an amount over the sum of the reserve price plus the margin to the surplus account, and identifying lesser winning bids that are valued at a price that is less than a combination of the reserve price plus the margin, including selectively accepting one or more of the identified lesser winning bids based at least in part on an amount in the surplus account. Selectively accepting includes deducting an amount associated with a respective deficiency of the identified lesser winning bid from the surplus account.

These and other implementations can each optionally include one or more of the following features. Initiating the surplus account can include estimating an amount of surplus that will occur in at least a portion of the time period and crediting the account initially to create a positive initial balance. Initiating the surplus account can include zero balancing the account. Selectively accepting one or more of the identified lesser winning bids can include evaluating a sponsor associated with an identified lesser winning bid, including determining an amount of subsidy that the sponsor has received in a prior time period, and selectively accepting only when the amount of subsidy is less than a predetermined threshold. Selectively accepting one or more of the identified lesser winning bids can include setting a lowest threshold for the lesser winning bids and only accepting a lesser winning bid that is valued at a price that is above the lowest threshold. The lowest threshold can be the reserve price for a respective slot. The method can further include determining that the time period has expired and after a time of expiration distributing to the publisher funds that are remaining in the surplus account. Distributing funds to the publisher can be prorated for winning bids that were accepted without subsidy. Accepting winning bids and selectively accepting one or more of the identified lesser winning bids can include providing respective content items associated with winning bids for presentation in a respective slot of the one or more web properties. Crediting can include crediting an amount that includes at least a portion of the margin. Selectively accepting one or more of the identified lesser winning bids can include accepting a non-winning bid in an auction that includes an identified lesser winning bid when a sponsor associated with the identified lesser winning bid is not qualified for a subsidy. Qualification can be based on a prior history of subsidies to the sponsor. The prior history can include history with other publishers other than the publisher associated with the one or more web properties. The method can further include crediting the publisher at least the reserve for each accepted bid. Crediting can occur at an end of the time period. The publisher can be credited an amount for each winning bid equal to at least the reserve and an additional amount that represents a portion of the surplus account that exists at the end of the time period. A fill rate for the publisher for the slots on the one or more web properties can be increased by an amount proportional to a value of lesser winning bids that are accepted.

In general, another innovative aspect of the subject matter described in this specification can be implemented in computer program products that include a computer program product tangibly embodied in a computer-readable storage device and comprising instructions. The instructions, when executed by one or more processors, cause the processor to: identify one or more web properties associated with a publisher, each web property including one or more slots for inclusion of third party content, where each slot has a reserve price which represents a minimum amount the publisher will accept for inclusion of the third party content in the slot when presented to viewers; determine the reserve price for each slot associated with the one or more web properties; determine a margin that is to be associated with a serving system, the margin being a portion that is paid to the serving system from a winning bid associated with an auction that is conducted; create a surplus account to be associated with a time period for the publisher, and initiate the surplus account; and evaluate current bids for slots on the one or more web properties including: accepting winning bids that are valued at a price that is greater than a combination of the reserve price plus the margin including crediting an amount over the sum of the reserve price plus the margin to the surplus account; and identifying lesser winning bids that are valued at a price that is less than a combination of the reserve price plus the margin, including selectively accepting one or more of the identified lesser winning bids based at least in part on an amount in the surplus account, where selectively accepting includes deducting an amount associated with a respective deficiency of the identified lesser winning bid from the surplus account.

In general, another innovative aspect of the subject matter described in this specification can be implemented in systems, including a system comprising one or more processors and one or more memory elements including instructions. The instructions, when executed, cause the one or more processors to: identify one or more web properties associated with a publisher, each web property including one or more slots for inclusion of third party content, where each slot has a reserve price which represents a minimum amount the publisher will accept for inclusion of the third party content in the slot when presented to viewers; determine the reserve price for each slot associated with the one or more web properties; determine a margin that is to be associated with a serving system, the margin being a portion that is paid to the serving system from a winning bid associated with an auction that is conducted; create a surplus account to be associated with a time period for the publisher, and initiate the surplus account; and evaluate current bids for slots on the one or more web properties including: accepting winning bids that are valued at a price that is greater than a combination of the reserve price plus the margin including crediting an amount over the sum of the reserve price plus the margin to the surplus account; and identifying lesser winning bids that are valued at a price that is less than a combination of the reserve price plus the margin, including selectively accepting one or more of the identified lesser winning bids based at least in part on an amount in the surplus account, where selectively accepting includes deducting an amount associated with a respective deficiency of the identified lesser winning bid from the surplus account.

Particular implementations may realize none, one or more of the following advantages. Fill rate (and overall revenue) can be increased while maintaining a serving system's margins and while honoring a publisher's reserve price. Manipulation and/or gaming a serving system by publishers and by content sponsors can be reduced.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for serving content.

FIG. 2 shows an example system for increasing fill rate while maintaining average margin.

FIGS. 3 and 4 are flowcharts of example processes for increasing fill rate while maintaining average margin for a content serving system.

FIG. 5 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for increasing fill rate (e.g., a rate at which slots are filed from available inventory) while maintaining average margin for a content serving system. In one example method, one or more web properties associated with a publisher are identified, each web property including one or more slots for inclusion of third party content. Each slot has a reserve price which represents a minimum amount the publisher will accept for inclusion of the third party content in the slot when presented to viewers. Fill rate refers to a rate at which content is included in slots on the publisher page as compared to not filled (such as when the reserve price is not met for a given occurrence). For a given slot, an average margin that is to be associated with a serving system for the publisher is maintained as opposed to strictly following a specific reserve at each opportunity. Maintaining an average includes accepting and subsidizing bids that are less than the reserve price (or the reserve price plus compensation for the serving system) by subsidizing low winning bids using a surplus that is accumulated in or predicted for a time period, based on accepted winning bids that exceed a sum of the reserve price plus compensation for the serving system.

For situations in which the systems discussed here collect and/or use personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

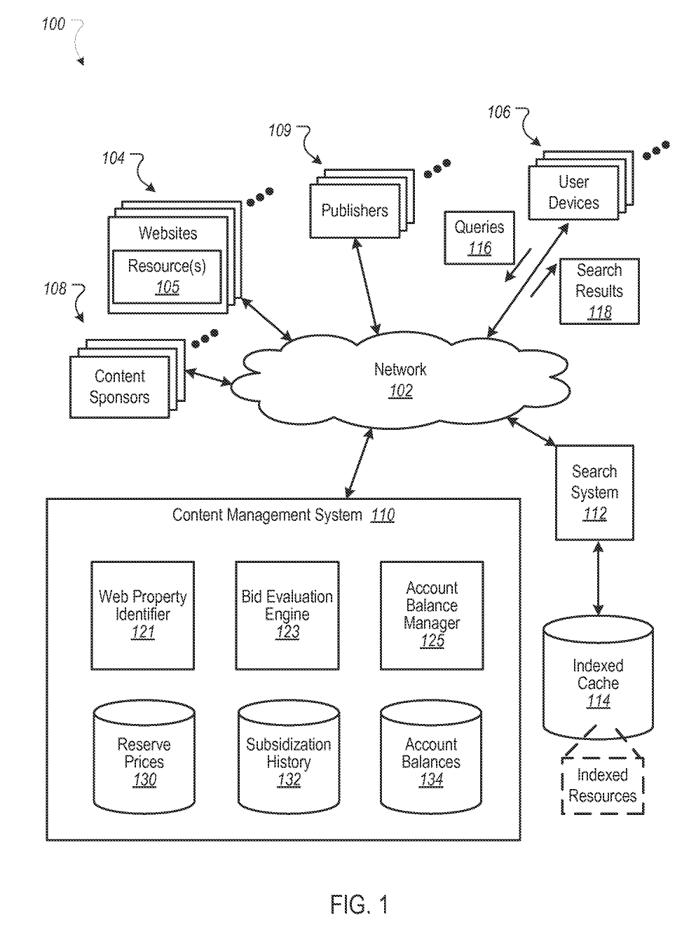

FIG. 1 is a block diagram of an example environment 100 for serving content. The example environment 100 includes a content management system 110 for selecting and providing content in response to requests for content, and for increasing fill rate while maintaining average margin. The example environment 100 includes a network 102, such as a local area network (LAN), a wide area network (WAN), the Internet, or a combination thereof. The network 102 connects websites 104 (e.g., addressable resources), user devices 106, content sponsors 108 (e.g., advertisers), publishers 109, and the content management system 110. The example environment 100 may include many thousands of websites 104, user devices 106, content sponsors 108 and publishers 109.

The environment 100 can include plural data stores, which can be stored locally by the content management system 110, stored somewhere else and accessible using the network 102, generated as needed from various data sources, or some combination of these. Further, some data stores described herein may include identifiers that can be used to match or access corresponding data records or other information that are stored elsewhere, e.g. locally and/or remotely.

A data store of reserve prices 130, for example, can include minimum amounts that publishers will accept for inclusion of third party content (e.g., creatives, advertisements) in maintained web properties. For example, each of the publishers 109 may maintain one or more of the websites 104, each website including one or more resources 105 (e.g., web pages). Each of the resources 105, for example, can include one or more portions (e.g. slots) for presenting third party content. The reserve prices 130, for example, can include the minimum amount that a publisher will accept for inclusion of third party content with a website, with a particular resource of the website, or within a particular portion of a particular resource of the website. The reserve prices 130 can be referenced in accordance with an auction for selecting content items provided by the content sponsors 106 for inclusion with one of the resources 105, for example. That is, values of bids of winning bidders at the auction (e.g., a value of a winning bid in a second price auction) can be compared to an associated reserve price to determine whether a winner of the auction is allowed to serve content responsive to a received request. As another example, the reserve prices 130 can be referenced in accordance with a programmatic deal in which a publisher indicates a reserve price and in which one or more of the content sponsors 106 indicate prices that they are willing to pay. Bidding and the evaluation of reserve prices is discussed in further detail below.

A data store of subsidization history 132, for example, can include data associated with bid subsidization which may occur such as when an auction winner's bid is below a certain value (e.g., an associated reserve price plus compensation for a serving system) for a given opportunity. For example, during an auction in which bids are provided by the content sponsors 106, a serving system (e.g., the content management system 110) may subsidize a value of a winning bid (e.g., a price charged to a winning bidder) that is less than a combination of the publisher's reserve price plus a margin for the serving system. Upon subsidizing the value of the bid, for example, data associated with the subsidization can be maintained for future reference (e.g., during a subsequent auction).

A data store of account balances 134, for example, can include surplus account balances for each of the publishers 109. For example, when a bid is accepted that is valued at an amount that is greater than a combination of a publisher's reserve price and a serving system's margin, a surplus account balance for the publisher can be credited. As another example, when a bid is accepted that is valued at an amount that is less than the combination of the publisher's reserve price and the serving system's margin, the surplus account balance can be debited. The account balances 134 can be used during an auction, for example, when determining whether a bid that is valued at an amount that is less than the combination of the publisher's reserve price and the serving system's margin is to be accepted.

The content management system 110 can include plural engines, some or all of which may be combined or separate, and may be co-located or distributed (e.g., connected over the network 102). A web property identifier 121, for example, can identify one or more web properties associated with a publisher, and can identify reserve prices that have been specified by the publisher for having third party content included with the web properties. For example, the web property identifier can identify each of the websites 104 and its corresponding publisher 109, and can use corresponding identifiers for each to access the data store of reserve prices 130 and to identify a reserve price that has been specified by a publisher for the inclusion of third party content with a web property. The reserve price can be associated with the web property and/or one or more slots of the web property, for example, and/or one or more features of the third party content, such as size (e.g., larger sizes may be associated with higher reserve prices) and/or duration of the content. As another example, the reserve price can be associated with one or more aspects associated with presentation of the third party content, such as a timeframe of when the third party content is presented, a geographic location of a device that presents the third party content, and/or an audience of the third party content.

A bid evaluation engine 123, for example, can evaluate current bids for slots on web properties. During an auction in which bids are provided by the content sponsors 108, for example, the bid evaluation engine 123 can determine a winning bid, and can determine whether the winning bid meets a reserve price specified by a publisher plus a margin specified by the content management system 110. If the winning bid does not meet the publisher's reserve price plus the margin (i.e., if the bid is a “lesser winning bid”), for example, the bid evaluation engine 123 can access the data store of account balances 134 to identify a surplus account balance of the publisher and can access the data store of subsidization history 132 to identify a subsidization history of a content sponsor associated with the winning bid. Based on the surplus account balance of the publisher and on the subsidization history of the content sponsor, for example, the bid evaluation engine 123 can determine whether to accept or reject a bid.

An account balance manager 125, for example, can credit or debit a publisher's account balance upon acceptance of a winning bid by the bid evaluation engine 123. For example, the account balance manager 125 can access the data store of account balances 134 to credit or debit a publisher's surplus account balance, based on whether a value of the winning bid is greater than or less than a combination of the publisher's reserve price and a serving system's margin. When the value of the winning bid is less than a combination of the publisher's reserve price and the serving system's margin, for example, a content sponsor that provided the winning bid may be subsidized with funds from the publisher's surplus account, and the account balance manager 125 can access the data store of subsidization history 132 to include a record of the subsidization.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. Search results pages can also include one or more slots in which other content items (e.g., advertisements) can be presented.

When a resource 105, search results 118 and/or other content (e.g., a video) are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In addition, when no search is performed or no keywords are available (e.g., because the user is not browsing a webpage), other information, such as information obtained from one or more snapshots, can be used to respond to the received request. In some implementations, the selection of the eligible content items can further depend on user signals, such as demographic signals, behavioral signals or other signals derived from a user profile.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

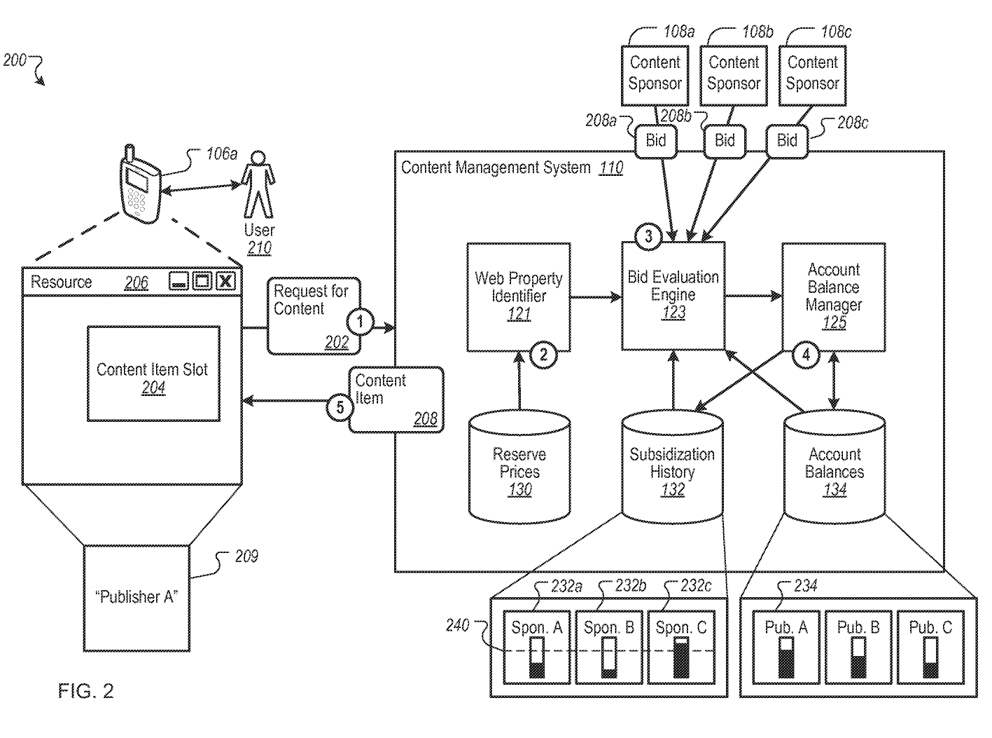

FIG. 2 shows an example system 200, including showing interactions/data flow, for increasing fill rate while maintaining average margin. For example, the content management system 110 can receive a request for content 202 from a user device 106a. The request for content 202, for example, can be a request for a content item (e.g., an advertisement) to fill a content item slot 204 on a resource 206. The content management system 110 can also receive one or more bids (e.g., bids 208a, 208b, and 208c) from one or more content sponsors (e.g., content sponsors 108a, 108b, and 108c) for having sponsored content (e.g., advertisements) provided to user devices for presentation within resource slots. A publisher of the resource 206, for example, may specify a reserve price (i.e., a minimum amount the publisher will accept for inclusion of the third party content in the slot 204). Operators of a content serving system (e.g., the content management system 110), for example, may specify a margin (e.g., a percentage of a winning bid amount or a flat rate) for facilitating the provision of third party content. When the value of a winning bid is greater than a combination of the reserve price plus the margin, for example, a surplus account for the publisher can be credited. When the value of a winning bid is less than a combination of the reserve price plus the margin (i.e., when the bid is a “lesser winning bid”), for example, the bid may be subsidized based on one or more conditions being satisfied and by debiting the publisher's surplus account. By maintaining a surplus account for each publisher and subsidizing particular bids, for example, a number of successful auctions (and overall revenue) can be increased (e.g., based on increased fill rate for the publisher) while honoring a publisher's reserve price and while maintaining a serving system's margin.

In some implementations, the following example stages can be used for increasing fill rate while maintaining average margin.

At stage 1, for example, the content management system 110 can receive the request for content 202 from the user device 106a. For example, the request for content 202 can be sent from a user device 106a, such as to fill the content item slot 204 (e.g., an ad slot) on the resource 206 being viewed by a user 210.

At stage 2, for example, the web property identifier 121 can identify one or more web properties associated with a publisher, and can identify reserve prices that have been specified by the publisher for having third party content included with the web properties. For example, the web property identifier 121 can identify the resource 206 and the content item slot 204 from the request for content 202, and can identify a corresponding publisher 209 (e.g., “Publisher A”) of the resource 206. The web property identifier 121, for example, can then access the reserve prices 130 to identify a reserve price that has been specified by the publisher 209 for the inclusion of a third party content item within the content item slot 204.

At stage 3, for example, the bid evaluation engine 123 can evaluate current bids for slots on web properties. During an auction in which the bids 208a, 208b, and 208c are provided by the respective content sponsors 108a, 108b, and 108c, for example, the bid evaluation engine 123 can determine a value of a winning bid (e.g., bid 208a), and can determine whether the winning bid meets a reserve price specified by the publisher 209 of the resource 206 (a web property) plus a margin specified by the content management system 110. If the winning bid 208a does not meet the publisher's reserve price plus the margin (i.e., if the bid is a “lesser winning bid”), for example, the bid evaluation engine 123 can access the account balances 134 to identify a surplus account balance 234 of the publisher 209. In some implementations, the bid evaluation engine 123 can access the subsidization history 132 to identify a subsidization history 232a of the content sponsor 108a that submitted the lesser winning bid 208a. Based on the surplus account balance 234 of the publisher 209 and, in some implementations, based on the subsidization history 232a of the content sponsor 108a, for example, the bid evaluation engine 123 can determine whether to accept or reject the lesser winning bid 208a. In the present example, the bid evaluation engine 123 determines that the surplus account balance 234 is sufficient to subsidize the lesser winning bid 208a, and that the subsidization history 232a of the content sponsor 108a is such that subsidizing the content sponsor 108a is appropriate.

At stage 4, for example, the account balance manager 125 can credit or debit a publisher's account balance upon acceptance of a winning bid by the bid evaluation engine 123. For example, the account balance manager 125 can access the account balances 134 to credit or debit the surplus account balance 234 of the publisher 209, based on whether a value of the winning bid is greater than or less than a combination of the publisher's reserve price and a serving system's margin. In the present example, the value of the winning bid 208a is less than a combination of the publisher's reserve price and the serving system's margin. Thus, in the present example, the content sponsor 108a that provided the winning bid 208a can be subsidized with funds from the publisher's surplus account balance 234, and the account balance manager 125 can access the data store of subsidization history 132 to include a record of the subsidization in the subsidization history 232a of the content sponsor 108a.

At stage 5, for example, the content management system 110 can provide the content item 208 responsive to the request for content 202. For example, the content item 208 can be provided to the user device 106a for display in the content item slot 204.

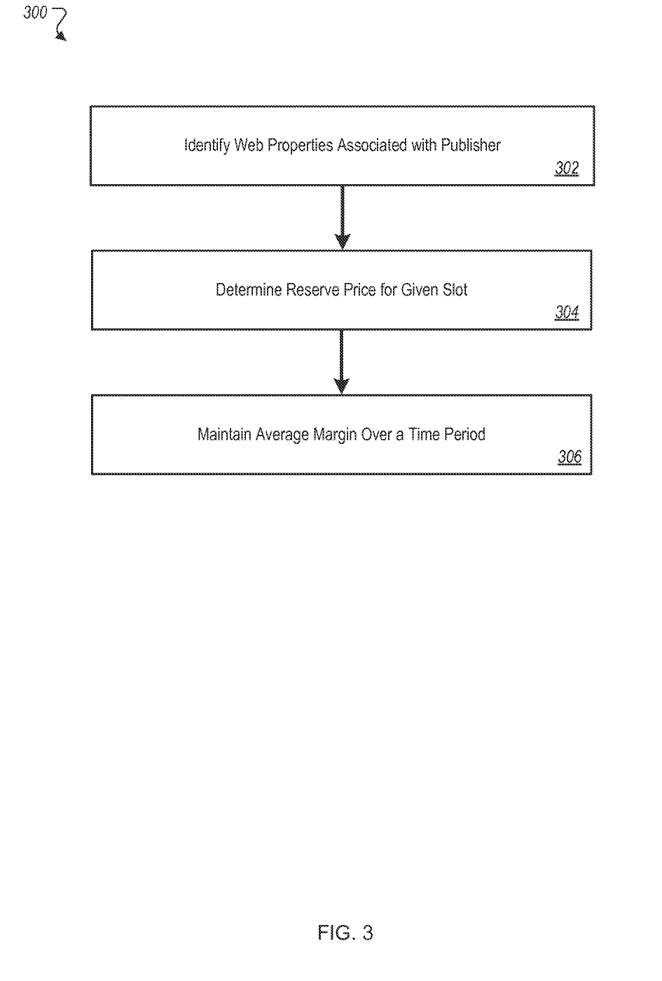

FIG. 3 is a flowchart of an example process 300 for increasing fill rate while maintaining average margin for a content serving system. In some implementations, the content management system 110 can perform steps of the process 300 using instructions that are executed by one or more processors. FIGS. 1-2 are used to provide example structures for performing the steps of the process 300.

One or more web properties associated with a publisher are identified (302). Based on data included in a request for content 202, for example, the web property identifier 121 can identify the resource 206 (e.g., a web page), and can determine that the resource is associated with the publisher 209. Each web property may include one or more slots for inclusion of third party content. In the present example, the resource 206 includes a content item slot 204 for inclusion of third party content items (e.g., creatives, advertisements) which may be provided by and/or sponsored by the content sponsors 108a, 108b, and 108c. Each slot may have a reserve price which represents a minimum amount the publisher will accept for inclusion of the third party content in the slot when the third party content is presented to viewers. For example, the publisher 209 may specify a reserve price for having third party content presented in a website, with a particular web page (e.g., resource 206) of the website, or within a particular content item slot (e.g., content item slot 204) of the web page.

A reserve price is determined for a given slot (304). For example, the web page identifier 121 can identify a web page that generated the request for content 202, and can use a corresponding web page identifier to identify the publisher 209 of the web page. Based on the web page identifier and a publisher identifier (and optionally, a slot identifier), for example, the web property identifier 121 can reference the reserve prices 130 to determine a reserve price for a given slot. As another example, reserve prices can be provided dynamically. In the present example, the publisher 209 may have specified a reserve price of $1.00 as a minimum amount for having third party content included in the content item slot 204.

Over a time period, an average margin is maintained for a serving system (306). For example, the content management system 110 can specify an average margin (e.g., a percentage of a winning bid amount or a flat rate) to be maintained across the time period (e.g., a day, a week, a month, or another suitable time period) for transactions that it facilitates between publishers and content sponsors. In the present example, the content management system 110 may specify its margin as a percentage (e.g., 10%, 20%, 30%, or another suitable value) of a closing price on an auction for the presentation of sponsored content.

Maintaining an average margin may include accepting and subsidizing bids that are valued at an amount that is less than a reserve price by subsidizing low winning bids using a surplus that is accumulated in or predicted for a given time period. For example, if a winning bid provided by one of the content sponsors 108a, 108b, or 108c is valued at an amount that is less than the reserve price (e.g., $1.00) specified by the publisher 209, the winning bid (i.e., a “lesser winning bid”) may be subsidized from the surplus account 234 of the publisher 209, a surplus account associated with the content management system 110, or both. In some implementations, a surplus account for a publisher may be credited with an appropriate amount before it is earned (e.g., in anticipation of a future surplus), based on a subsidization history of bids submitted for the inclusion of third party content with web properties of the publisher. For example, based on the subsidization history 132, the content management system 110 may determine that the publisher 209 regularly accumulates a particular amount in the surplus account balance 234 during the time period. In the present example, the particular amount or a portion of the amount can be credited to the surplus account balance 234 at the beginning of the time period.

The surplus can be based on accepted winning bids that exceed a sum of the reserve price plus compensation (e.g., margin) for the serving system. For example, when a winning bid provided by one of the content sponsors 108a, 108b, or 108c is valued at an amount that is greater than a combination of the publisher's reserve price and the serving system's margin, a surplus amount can be added to the surplus account balance 234 of the publisher 209, a surplus account balance associated with the content management system 110, or both. Surplus account balances may be applied to subsidize subsequent lesser winning bids during the time period, for example, and at the end of the time period, the surplus account balances can be distributed to the publisher 209, the content management system 110, or both, such that the serving system's average margin is maintained.

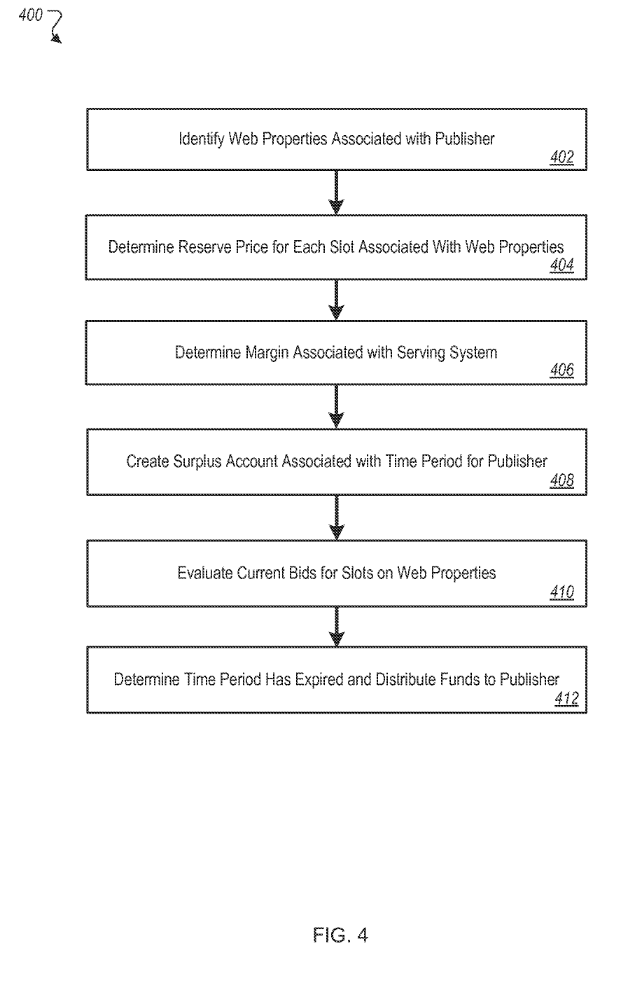

FIG. 4 is a flowchart of an example process 400 for increasing fill rate while maintaining average margin for a content serving system. In some implementations, the content management system 110 can perform steps of the process 400 using instructions that are executed by one or more processors. FIGS. 1-2 are used to provide example structures for performing the steps of the process 400.

One or more web properties associated with a publisher are identified (402). Based on data included in the request for content 202, for example, the web property identifier 121 can identify the resource 206 (e.g., a web page), and can determine that the resource is associated with the publisher 209. Each web property may include one or more slots for inclusion of third party content. In the present example, the resource 206 includes a content item slot 204 for inclusion of third party content items (e.g., creatives, advertisements) which may be provided by and/or sponsored by the content sponsors 108a, 108b, and 108c. Each slot may have a reserve price which represents a minimum amount the publisher will accept for inclusion of the third party content in the slot when the third party content is presented to viewers. For example, the publisher 209 may specify a reserve price for having third party content presented in a website, with a particular web page (e.g., resource 206) of the website, or within a particular content item slot (e.g., content item slot 204) of the web page.

A reserve price for each slot associated with the one or more web properties is determined (404). For example, the web page identifier 121 can identify a web page that generated the request for content 202, and can use a corresponding web page identifier to identify the publisher 209 of the web page. Based on the web page identifier, a publisher identifier, and a slot identifier (as necessary), for example, the web property identifier 121 can reference the reserve prices 130 to determine a reserve price for each slot on the resource 206. As another example, reserve prices can be provided dynamically. In the present example, the publisher 209 has specified a reserve price of $1.00 as a minimum amount for having third party content included in the content item slot 204.

A margin (e.g., an average margin and/or a per transaction margin) that is to be associated with a serving system is determined (406). The margin is a portion that is paid to the serving system from a winning bid associated with an auction that is conducted. For example, the content management system 110 can specify a margin (e.g., a percentage of a winning bid amount or a flat rate) to be applied to each transaction that it facilitates between publishers and content sponsors. In the present example, the content management system 110 may specify its margin as a percentage (e.g., 20%) of a value associated with winning bid based on a closing price of an auction in which content sponsors (e.g., the content sponsors 108a, 108b, and 108c) bid for having their sponsored content included with the resource 206 in the content item slot 204.

A surplus account to be associated with a time period for the publisher is created and initiated (408). For example, at the beginning of the time period (e.g., a day, a week, a month, or another suitable time period), the content management system 110 can create and initiate a surplus account for each publisher in a group of publishers that have agreed to have sponsored content included with their web properties during the time period. The publishers' surplus accounts can be maintained at the data store of account balances 134, for example. As another example, multiple publishers (e.g., parties in a cooperative, such as parent and child companies) can share a surplus account. As another example, a surplus account can be associated with a website or with a collection of websites.

In some implementations, initiating the surplus account may include estimating an amount of surplus that will occur in at least a portion of the time period and crediting the account initially to create a positive initial balance. For example, based on the subsidization history 132, the content management system 110 may determine that the publisher 209 regularly (e.g., as defined by a percentage amount of time periods, such as 90%, 95%, 99%, or another suitable value) accumulates a particular amount in the surplus account balance 234 at some point in time during one or more past time periods. In the present example, the particular amount or a portion of the amount can be credited by the account balance manager 125 to the surplus account balance 234 at the beginning of the time period. As another example, a surplus amount that remains in an account at the end of a time period, or a portion of the amount, can be carried over in the account into the next time period. In some implementations, projected accumulations can be processed to add to a balance in surplus account balance 234 to cover a single overage, such as in real time as opposed to at a beginning of a time period.

In some implementations, initiating the surplus account may include zero balancing the account. For example, each publisher in a group of publishers can initially be associated with an account balance of zero, each of the publishers' account balances may be maintained during a time period as the balances are credited and debited, and any surplus amount that remains in an account at the conclusion of the time period can be distributed to a publisher associated with the account. As another example, publishers with a history of positive surplus account balances may be credited at the beginning of a time period, and publishers without such a history (e.g., publishers that have recently registered with the content management system 110) may initially be associated with account balances of zero. As another example, publishers with a history of positive surplus account balances may initially be associated with account balances of zero, and may be allowed to have negative account balances in at least a portion of the time period. A negative account balance, for example, may be based on an amount that a publisher regularly accumulates in its surplus account balance at some point in time during past time periods. Subsidization, for example, may or may not be suppressed while an account balance is negative, or has an amount that is at or under a positive threshold value.

Current bids for slots on the one or more web properties are evaluated (410). For example, the bid evaluation engine 123 can evaluate each of the bids 208a, 208b, and 208c, provided by the respective content sponsors 108a, 108b, and 108c. Each of the bids 208a, 208b, and 208c, for example, can be for having one or more content items that are sponsored by the respective content sponsor included in the content item slot 204 of the resource 206. Bids can be evaluated in an auction, such as a second-price auction or another suitable type of auction. The value of a winning bid, for example, may correspond to the closing price for a content item slot in an auction in which the bid was submitted.

Winning bids that are valued at a price that is greater than a combination of the reserve price plus the margin are accepted. For example, the content sponsor 108a may submit a bid in an auction, and the bid may be the winning bid in the auction and may be valued at $2.00 (e.g., based on a second price auction). In the present example, based on the publisher's reserve price (e.g., $1.00), and the serving system's margin (e.g., 20% of a value associated with a winning bid), the bid evaluation engine 123 can determine that the winning bid valued at $2.00 is greater than the reserve price of $1.00 plus the system's margin of $0.40 (20% of $2.00), or $1.40, and thus can accept the bid. Accepting the winning bids can include crediting an amount over the sum of the reserve price plus the margin to the surplus account. In the present example, account balance manager 125 can determine that the valued amount of the winning bid that is over the sum of the reserve price plus the margin is $0.60 ($2.00-$1.40), and can access the account balances 134 to credit the account balance 234 of the publisher 209 an amount of $0.60.

Lesser winning bids that are valued at a price that is less than a combination of the reserve price plus the margin are identified. For example, in a subsequent auction, the content sponsor 108b may submit a bid that is valued at $1.20, and the bid may be the winning bid in the auction. In the present example, based on the publisher's reserve price (e.g., $1.00), and the serving system's margin (e.g., 20% of the winning bid value), the bid evaluation engine 123 can determine that the winning bid valued at $1.20 is less than the reserve price of $1.00 plus the system's margin of $0.24 (20% of $1.20), or $1.24. As the winning bid (e.g., valued at $1.20) submitted by content sponsor 108b is valued at less than the combination of the publisher's reserve price plus the margin (e.g., $1.24), for example, the bid evaluation engine 123 can identify the bid as a “lesser winning bid,” which may or may not be accepted by the content management system 110.

In some implementations, the serving system's margin for a lesser winning bid may be based on a bid that would be sufficient to meet a combination of a publisher's reserve price plus the serving system's target margin. For example, a bid valued at $1.25 would be sufficient to meet a reserve price of $1.00, and would provide the serving system (e.g., the content management system 110) with a target margin of 20%, or $0.25. When evaluating a lesser winning bid, for example, the bid evaluation engine 123 can base the evaluation on a fixed value which reflects the serving system's target margin (e.g., $0.25) when a publisher's reserve price is met, or can base the evaluation on a percentage (e.g., 20%) of the value of the lesser winning bid.

One or more of the identified lesser winning bids may be selectively accepted based at least in part on an amount in the associated surplus account. For example, the bid evaluation engine 123 can access the account balances 134 to determine the surplus account balance 234 of the publisher 209. A determination by the bid evaluation engine 123 of whether to accept a lesser winning bid, for example, can be based on whether the surplus account balance is greater than the difference between the combination of the publisher's reserve price and the serving system's margin, and the value of the lesser winning bid. In the present example, the bid evaluation 123 determines that the surplus account balance 234 of the publisher 209 is $0.60, which is greater than the difference between the combination of the publisher's reserve price and the serving system's margin, and the value of the lesser winning bid, or $0.04 ($1.24-$1.20). Thus, in the present example, the bid evaluation engine 123 can accept the lesser winning bid of $1.20.

Selectively accepting one or more of the identified lesser winning bids may include deducting an amount associated with a respective deficiency of the identified lesser winning bid from the surplus account. For example, after the bid evaluation engine 123 accepts a lesser winning bid, the account balance manager 125 can deduct the amount associated with the deficiency of the lesser winning bid from an appropriate publisher account maintained at the data store of account balances 134. The respective deficiency can be the difference between the combination of the publisher's reserve price and the serving system's margin, and the lesser winning bid, or $0.04 in the present example. The account balance manager 125, for example, can deduct the amount associated with the respective deficiency (e.g., $0.04) from the surplus account balance 234 (e.g., $0.60) of the publisher 209 to update the surplus account balance 234 as having a value of $0.56.

In some implementations, selectively accepting one or more of the identified lesser winning bids may include evaluating a sponsor associated with an identified lesser winning bid. For example, in another subsequent auction, the content sponsor 108c may submit a bid, and the bid may be the winning bid in the auction and may be valued at $1.10. In the present example, based on the publisher's reserve price (e.g., $1.00), and the serving system's margin (e.g., 20% of the winning bid value), the bid evaluation engine 123 can determine that the winning bid valued at $1.10 is less than the reserve price of $1.00 plus the system's margin of $0.22 (20% of $1.10), or $1.22. As the winning bid (e.g., valued at $1.10) submitted by content sponsor 108c is less than the combination of the publisher's reserve price plus the margin (e.g., $1.22), for example, the bid evaluation engine 123 can identify the bid as a “lesser winning bid,” which may or may not be accepted by the content management system 110, based at least in part on subsidization history 232c of the content sponsor 108c.

In some implementations, an amount of subsidy that the sponsor has received in a prior time period may be determined and the identified lesser winning bid may be selectively accepted only when the amount of subsidy is less than a predetermined threshold. For example, the bid evaluation engine 123 can access the data store of subsidization history 132 to reference subsidization history 232c of content sponsor 108c. The subsidization history 132, for example, can include records of subsidization events for each of the content sponsors 108a, 108b, and 108c. Each of the records, for example, can include data such as a content sponsor identifier, a publisher identifier, a website identifier, a resource identifier, a content item slot identifier, a bid value, a subsidization value, a timestamp value, and other appropriate data associated with each subsidization event. Subsidization history 232a, 232b, and 232c, for each of the respective content sponsors 108a, 108b, and 108c, for example, can be maintained for each publisher in a group of publishers, and/or may aggregated for all of the publishers in the group. In the present example, the bid evaluation engine 123 can determine that a total amount of subsidization provided by the publisher 209 (or all publishers) for lesser winning bids submitted by content sponsor 108c in one or more prior time periods (e.g., yesterday, last week, last month, or another suitable time period) is greater than (or equal to) the threshold 240 (e.g., an amount value, a number of subsidized bids, or both). Thus, in the present example, the bid evaluation engine 123 may reject the lesser winning bid (e.g., valued at $1.10) submitted by content sponsor 108c. As another example, if the content sponsor 108b had submitted the lesser winning bid (e.g., valued at $1.10), and if the total amount of subsidization provided by the publisher 209 (or all publishers) for lesser winning bids submitted by content sponsor 108b in one or more prior time periods is less than the threshold 240, the bid evaluation engine 123 may accept the lesser winning bid (e.g., valued at $1.10), and the account balance manager 125 may add a record of the subsidization event to the subsidization history 232b.

In some implementations, determining an amount of subsidization provided by one or more publishers for lesser winning bids submitted by a content sponsor may include evaluating subsidization events during a current time period. For example, the bid evaluation engine 132 can evaluate subsidization history 232c for the content sponsor 108c for the current time period (e.g., a current day, a current week, a current month, or another suitable time period). As another example, the bid evaluation engine 132 can evaluate subsidization history 232c for the content sponsor 108c for the current time period and one or more prior time periods. As another example, the content management system 110 can periodically truncate or purge the subsidization history 132 such that data corresponding to a predetermined amount of time (e.g., a day, a week, a month, or another suitable amount of time) is maintained and analyzed.

In some implementations, selectively accepting one or more of the identified lesser winning bids may include setting a lowest threshold for the lesser winning bids and only accepting a lesser winning bid that is valued at a price that is at or above the lowest threshold. For example, the publisher 209 can specify that the lowest threshold is the reserve price specified by the publisher for website, web page, or a respective slot. As another example, the publisher 209 can specify that the lowest threshold for the lesser winning bids is a value over or under the reserve price. Lesser winning bids that fall below the lowest threshold, for example, can be rejected by the bid evaluation engine 123. The lowest threshold specified by the publisher 209 may or may not be communicated to the content sponsors 108a, 108b, or 108c, for example.

In some implementations, selectively accepting one or more of the identified lesser winning bids may include accepting a non-winning bid in an auction that includes an identified lesser winning bid when a sponsor associated with the identified lesser winning bid is not qualified for a subsidy. For example, in another subsequent auction, the content sponsor 108b may submit a bid of $1.05, and the content sponsor 108c may submit a bid of $1.10. In the present example, the bid of $1.10 can be identified by the bid evaluation engine 123 as a lesser winning bid. However, the content sponsor 108c that submitted the bid in the present example may not be qualified for a subsidy, whereas the content sponsor 108b may be qualified for the subsidy. In the present example, the non-winning bid of $1.05 submitted by the content sponsor 108b may be accepted by the bid evaluation engine 123 instead of the bid of $1.10 submitted by the content sponsor 108c.

In some implementations, a content sponsor's qualification for subsidization of a non-winning bid can be based on a prior history of subsidies to the sponsor. For example, the bid evaluation engine 123 can access the data store of subsidization history 132 to reference the subsidization history 232b of content sponsor 108b and to reference the subsidization history 232c of content sponsor 108c. The prior subsidization history can include history with the publisher 209 associated with the resource 206, and can include history with publishers other than the publisher 209, that are associated with one or more other web properties. Based on the subsidization history 232b and 232c, for example, the bid evaluation engine 123 can determine that lesser winning bids previously submitted by the content sponsor 108b have been subsidized (e.g., by the publisher 209, or by the publisher 209 and other publishers) at a level under a threshold value (e.g., based on an amount, a number of subsidization, or both), and can determine that lesser winning bids previously submitted by the content sponsor 108c have been subsidized at a level that meets or exceeds the threshold value. Thus, in the present example, the bid evaluation engine 123 may reject a lesser winning bid (e.g., bid 208c) submitted by the content sponsor 108c and may accept a non-winning bid (e.g., bid 208b) submitted by the content sponsor 108b. By selectively accepting and rejecting lesser winning bids provided by content sponsors based on subsidization history of the content sponsors, for example, the content management system 110 can reduce or prevent possible gaming of a selection strategy used by the bid evaluation engine 123.

In some implementations, accepting winning bids and selectively accepting one or more of the identified lesser winning (or non-winning) bids may include providing respective content items associated with winning (or non-winning) bids for presentation in a respective slot of the one or more web properties. For example, when the bid evaluation engine 123 selects a winning bid 208a submitted by content sponsor 108a or selects a lesser winning bid 208b submitted by content sponsor 108b, the content management system 110 can provide a content item (e.g., content item 208) that is associated with a content sponsor that submitted the selected bid.

In some implementations, crediting may include crediting an amount that includes at least a portion of the margin. For example, when the bid evaluation engine 123 accepts a winning bid or a lesser winning bid, a serving system (e.g., the content management system 110) can apply a portion of its margin to its own surplus account balance, a surplus account balance associated with a publisher (e.g., the publisher 209) of a web property (e.g., the resource 206), or both.

In some implementations, the publisher may be credited at least the reserve for each accepted bid. For example, when the bid evaluation engine 123 accepts a bid, the account balance manager can credit a publisher (e.g., the publisher 209) at least the publisher's reserve, and can credit (or debit) the publisher's surplus account balance, based on whether a value of the bid has covered the publisher's reserve plus the serving system's margin. Crediting the publisher 209, for example, can occur at an end of the time period. The publisher 209, for example, can be credited an amount for each winning bid equal to at least the publisher's reserve, and can be credited an additional amount that represents the publisher's surplus account balance 234 or a portion of the balance that exists at the end of the time period.

In some implementations, a fill rate for the publisher for the slots on the one or more web properties may be increased by an amount proportional to a value of lesser winning bids that are accepted. By accepting lesser winning bids from content sponsors (e.g., the content sponsors 108a, 108b, and 108c) for content items to be provided with one or more web properties (e.g., the resource 206) of the publisher 209, for example, the content management system 110 can increase the fill rate of the publisher's web properties, thus increasing overall revenue for the publisher 209, while maintaining margin for the content management system 110.

A determination can be made that the time period has expired, and after a time of expiration, funds that are remaining in the surplus account may be distributed to a publisher (412). For example, after the end of the time period (e.g., a day, a week, a month, or another suitable time period), the account balance manager 125 can distribute the remaining surplus account balance 234 to the publisher 209. As another example, the surplus account balance 234 (or a portion of the account balance) may be carried over into the next time period.

In some implementations, distributing funds to the publisher may be prorated for winning bids that were accepted without subsidy. For example, when distributing the remaining surplus account balance 234 to the publisher 209 after the end of the time period, the surplus account balance 234 can be allocated proportionally to each transaction that corresponds to a winning bid that was accepted without subsidy. As another example, when distributing the remaining surplus account balance 234 to the publisher 209 after the end of the time period, the surplus account balance 234 can be allocated proportionally to each transaction regardless of whether the transaction involved a winning bid or a lesser winning bid.

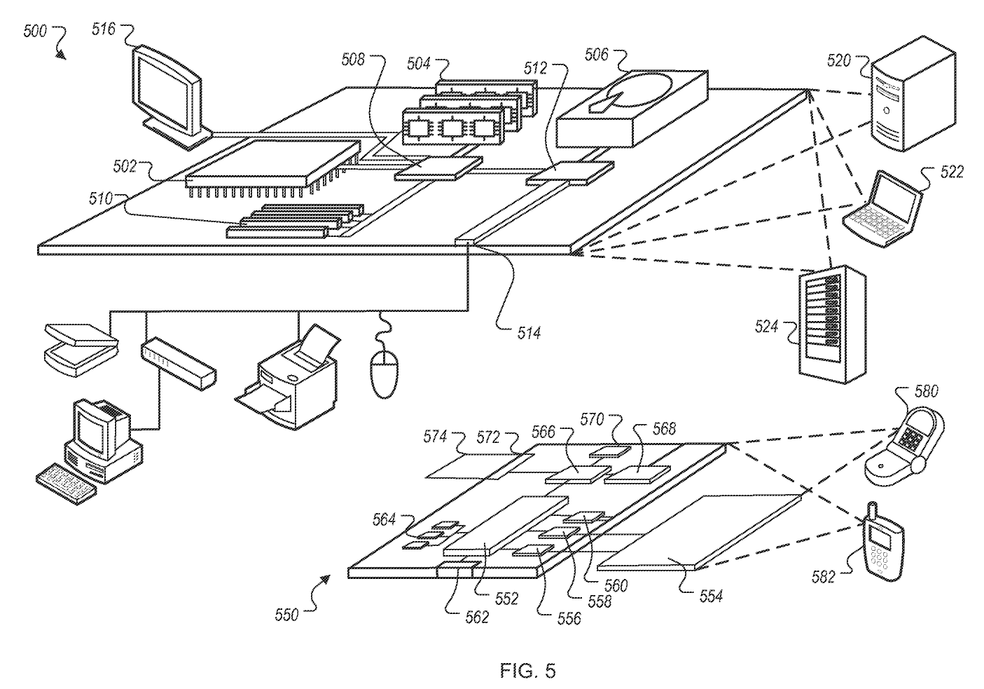

FIG. 5 is a block diagram of example computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 500 is further intended to represent any other typically non-mobile devices, such as televisions or other electronic devices with one or more processers embedded therein or attached thereto. Computing device 550 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 500 includes a processor 502, memory 504, a storage device 506, a high-speed controller 508 connecting to memory 504 and high-speed expansion ports 510, and a low-speed controller 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed controller 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high-speed controller 508 manages bandwidth-intensive operations for the computing device 500, while the low-speed controller 512 manages lower bandwidth-intensive operations. Such allocation of duties is an example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed bus 514. The low-speed bus 514 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as computing device 550. Each of such devices may contain one or more of computing devices 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The computing device 550 may also be provided with a storage device, such as a micro-drive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the computing device 550, such as control of user interfaces, applications run by computing device 550, and wireless communication by computing device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of computing device 550 with other devices. External interface 562 may provide, for example, for wired communication (e.g., via a docking procedure) or for wireless communication (e.g., via Bluetooth® or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to computing device 550 through expansion interface 572, which may include, for example, a subscriber identification module (SIM) card interface. Such expansion memory 574 may provide extra storage space for computing device 550, or may also store applications or other information for computing device 550. Specifically, expansion memory 574 may include instructions to carry out or supplement the processes described above, and may include secure information also. Thus, for example, expansion memory 574 may be provide as a security module for computing device 550, and may be programmed with instructions that permit secure use of computing device 550. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Computing device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 568 (e.g., a radio-frequency transceiver). In addition, short-range communication may occur, such as using a Bluetooth®, WiFi, or other such transceiver (not shown). In addition, GPS receiver module 570 may provide additional wireless data to computing device 550, which may be used as appropriate by applications running on computing device 550.

Computing device 550 may also communicate audibly using audio codec 560, which may receive spoken information from a user and convert it to usable digital information. Audio codec 560 may likewise generate audible sound for a user, such as through a speaker, e.g., in a handset of computing device 550. Such sound may include sound from voice telephone calls, may include recorded sound (e.g., voice messages, music files, etc.) and may also include sound generated by applications operating on computing device 550.

The computing device 550 may be implemented in a number of different forms, as shown in the figure. For example, it may be implemented as a cellular telephone 580. It may also be implemented as part of a smartphone 582, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by a content serving system for increasing fill rate while maintaining average margin for the content serving system, the method comprising:
identifying one or more web properties associated with a publisher, each web property including one or more slots for inclusion of third party content, wherein each slot has a reserve price, stored in computer memory, which represents a minimum amount the publisher will accept for inclusion of the third party content in the slot when presented to viewers;
for a given slot of a given web property, determining the reserve price;
determining a margin that is to be associated with the content serving system;
creating, in computer memory and by one or more computing devices, a surplus account for the publisher;
receiving, from a first user device and by one or more computing devices, a first request for content to fill the given slot of the given web property for presentation by the first user device;
accepting, from a first sponsor and by one or more computing devices, a winning bid from among a first plurality of bids for having content included in the given slot of the given web property, the winning bid being valued at a price that is greater than a combination of the reserve price plus the margin, wherein accepting the winning bid includes crediting an amount over the sum of the reserve price plus the margin to the surplus account;
providing, by one or more computing devices, content of the first sponsor for presentation in the given slot in response to accepting the winning bid;
receiving, from a second user device and by one or more computing devices, a second request for content to fill the given slot of the given web property for presentation by the second user device;
determining, by one or more computing devices, that no bids of a second plurality of bids for having content included in the given slot of the given web property are greater than a combination of the reserve price plus the margin;
determining, by one or more computing devices, whether an amount in the surplus account is sufficient to subsidize a lesser winning bid;
when (i) an amount in the surplus account is sufficient to subsidize the lesser winning bid and (ii) a subsidization history of the second content sponsor indicates that a subsidization value provided to the second sponsor by multiple publishers is less than a specified amount, accepting, from a second sponsor and by one or more computing devices, the lesser winning bid from among the second plurality of bids, the lesser winning bid being valued at a price that is less than a combination of the reserve price plus the margin, wherein accepting the lesser winning bid includes:
(i) deducting an amount associated with a deficiency of the lesser winning bid from the surplus account stored in computer memory; and
(ii) providing, to the second user device, electronic content of the second sponsor for presentation in the given slot in response to accepting the lesser winning bid; and
when an amount in the surplus account is insufficient to subsidize the lesser winning bid or the subsidization history of the second content sponsor indicates that the subsidization value provided to the second sponsor by multiple publishers is greater than the specified amount, not accepting, from the second sponsor, the lesser winning bid, wherein not accepting the lesser winning bid includes not providing the electronic content of the second sponsor for presentation in the given slot.

2. A computer-implemented method performed by a content serving system for increasing fill rate while maintaining average margin for the content serving system, the method comprising:
identifying one or more web properties associated with a publisher, each web property including one or more slots for inclusion of third party content, wherein each slot has a reserve price which represents a minimum amount the publisher will accept for inclusion of the third party content in the slot when presented to viewers;
determining the reserve price for each slot associated with the one or more web properties;
determining a margin that is to be maintained for the content serving system, the margin being a portion that is paid to the content serving system from a winning bid in an auction that is conducted;
creating, by one or more computing devices, a surplus account to be associated with a time period for the publisher, and initiating the surplus account;
receiving, from a first user device and by one or more computing devices, a first request for content to fill a given slot of a given web property for presentation by the first user device;
accepting, from a first sponsor and by one or more computing devices, a winning bid from among a first plurality of bids for having content included in the given slot of the given web property, the winning bid being valued at a price that is greater than a combination of the reserve price plus the margin, wherein accepting the winning bid includes crediting an amount over the sum of the reserve price plus the margin to the surplus account;
providing, by one or more computing devices, content of the first sponsor for presentation in the given slot in response to accepting the winning bid;
receiving, from a second user device and by one or more computing devices, a second request for content to fill the given slot of the given web property for presentation by the second user device;
determining, by one or more computing devices, that no bids of a second plurality of bids for having content included in the given slot of the given web property are greater than a combination of the reserve price plus the margin;
determining, by one or more computing devices, whether an amount in the surplus account is sufficient to subsidize a lesser winning bid;
increasing a fill rate for the given web property when (i) an amount in the surplus account is sufficient to subsidize the lesser winning bid and (ii) a subsidization history of the second content sponsor indicates that a subsidization value provided to the second sponsor by multiple publishers is less than a specified amount, including:
accepting, from a second sponsor and by one or more computing devices, the lesser winning bid from among the second plurality of bids, the lesser winning bid being valued at a price that is less than a combination of the reserve price plus the margin, wherein accepting the lesser winning bid includes:
(i) deducting an amount associated with a deficiency of the lesser winning bid from the surplus account; and
(ii) providing content of the second sponsor for presentation in the given slot in response to accepting the lesser winning bid; and
when an amount in the surplus account is insufficient to subsidize the lesser winning bid or the subsidization history of the second content sponsor indicates that the subsidization value provided to the second sponsor by multiple publishers is greater than the specified amount, not accepting, from the second sponsor, the lesser winning bid, wherein not accepting the lesser winning bid includes not providing the content of the second sponsor for presentation in the given slot.

3. The computer-implemented method of claim 2, wherein initiating the surplus account includes estimating an amount of surplus that will occur in at least a portion of the time period and crediting the surplus account initially to create a positive initial balance.

4. The computer-implemented method of claim 2, wherein initiating the surplus account includes zero balancing the surplus account.

5. (canceled)

6. The computer-implemented method of claim 2, wherein accepting, from the second sponsor, the lesser winning bid includes setting a lowest threshold for lesser winning bids and only accepting an identified lesser winning bid that is valued at a price that is above the lowest threshold.

7. The computer-implemented method of claim 6, wherein the lowest threshold is the reserve price for a respective slot.

8. The computer-implemented method of claim 2, further comprising determining that the time period has expired and after a time of expiration distributing to the publisher funds that are remaining in the surplus account.

9. The computer-implemented method of claim 8, wherein distributing funds to the publisher is prorated for winning bids that were accepted without subsidy.

10. The computer-implemented method of claim 2, wherein accepting, from the first sponsor, the winning bid and accepting, from the second sponsor, the lesser winning bid includes providing respective content items associated with winning bids for presentation in a respective slot of the one or more web properties.

11. The computer-implemented method of claim 2, wherein crediting includes crediting an amount that includes at least a portion of the margin.

12. The computer-implemented method of claim 2, wherein accepting, from the second sponsor, the lesser winning bid includes accepting a non-winning bid in an auction that includes the non-winning bid and an identified lesser winning bid when a sponsor associated with the identified lesser winning bid is not qualified for a subsidy.

13. (canceled)

14. (canceled)

15. The computer-implemented method of claim 2, further comprising crediting the publisher at least the reserve for each accepted bid.

16. The computer-implemented method of claim 15, wherein crediting occurs at an end of the time period, and wherein the publisher is credited an amount for each winning bid equal to at least the reserve and an additional amount that represents a portion of the surplus account that exists at the end of the time period.

17. The computer-implemented method of claim 2, wherein a fill rate for the publisher for the slots on the one or more web properties is increased by an amount proportional to a value of lesser winning bids that are accepted.

18. A computer program product embodied in a non-transitive computer-readable medium including instructions, that when executed, cause one or more processors to perform operations comprising:
identifying one or more web properties associated with a publisher, each web property including one or more slots for inclusion of third party content, wherein each slot has a reserve price which represents a minimum amount the publisher will accept for inclusion of the third party content in the slot when presented to viewers;
determining the reserve price for each slot associated with the one or more web properties;
determining a margin that is to be associated with a serving system, the margin being a portion that is paid to the serving system from a winning bid associated with an auction that is conducted;
creating, by one or more computing devices, a surplus account to be associated with a time period for the publisher, and initiating the surplus account;
receiving, from a first user device and by one or more computing devices, a first request for content to fill a given slot of a given web property for presentation by the first user device;
accepting, from a first sponsor and by one or more computing devices, a winning bid from among a first plurality of bids for having content included in the given slot of the given web property, the winning bid being valued at a price that is greater than a combination of the reserve price plus the margin, wherein accepting the winning bid includes crediting an amount over the sum of the reserve price plus the margin to the surplus account;
providing, by one or more computing devices, content of the first sponsor for presentation in the given slot in response to accepting the winning bid;
receiving, from a second user device and by one or more computing devices, a second request for content to fill the given slot of the given web property for presentation by the second user device;
determining, by one or more computing devices, that no bids of a second plurality of bids for having content included in the given slot of the given web property are greater than a combination of the reserve price plus the margin;
determining, by one or more computing devices, whether an amount in the surplus account is sufficient to subsidize a lesser winning bid;
when (i) an amount in the surplus account is sufficient to subsidize the lesser winning bid and (ii) a subsidization history of the second content sponsor indicates that a subsidization value provided to the second sponsor by multiple publishers is less than a specified amount, accepting, from a second sponsor and by one or more computing devices, the lesser winning bid from among the second plurality of bids, the lesser winning bid being valued at a price that is less than a combination of the reserve price plus the margin, wherein accepting the lesser winning bid includes:
(i) deducting an amount associated with a deficiency of the lesser winning bid from the surplus account; and
(ii) providing content of the second sponsor for presentation in the given slot in response to accepting the lesser winning bid; and
when an amount in the surplus account is insufficient to subsidize the lesser winning bid or the subsidization history of the second content sponsor indicates that the subsidization value provided to the second sponsor by multiple publishers is greater than the specified amount, not accepting, from the second sponsor, the lesser winning bid, wherein not accepting the lesser winning bid includes not providing the content of the second sponsor for presentation in the given slot.

19. A system comprising:
one or more processors; and
one or more memory elements including instructions that, when executed, cause the one or more processors to perform operations comprising:
identifying one or more web properties associated with a publisher, each web property including one or more slots for inclusion of third party content, wherein each slot has a reserve price which represents a minimum amount the publisher will accept for inclusion of the third party content in the slot when presented to viewers;
determining the reserve price for each slot associated with the one or more web properties;
determining a margin that is to be associated with a serving system, the margin being a portion that is paid to the serving system from a winning bid associated with an auction that is conducted;
creating, by one or more computing devices, a surplus account to be associated with a time period for the publisher, and initiating the surplus account;
receiving, from a first user device and by one or more computing devices, a first request for content to fill a given slot of a given web property for presentation by the first user device;
accepting, from a first sponsor and by one or more computing devices, a winning bid from among a first plurality of bids for having content included in the given slot of the given web property, the winning bid being valued at a price that is greater than a combination of the reserve price plus the margin, wherein accepting the winning bid includes crediting an amount over the sum of the reserve price plus the margin to the surplus account;
providing, by one or more computing devices, content of the first sponsor for presentation in the given slot in response to accepting the winning bid;
receiving, from a second user device and by one or more computing devices, a second request for content to fill the given slot of the given web property for presentation by the second user device;
determining, by one or more computing devices, that no bids of a second plurality of bids for having content included in the given slot of the given web property are greater than a combination of the reserve price plus the margin; determining, by one or more computing devices, whether an amount in the surplus account is sufficient to subsidize a lesser winning bid;
when (i) an amount in the surplus account is sufficient to subsidize the lesser winning bid and (ii) a subsidization history of the second content sponsor indicates that a subsidization value provided to the second sponsor by multiple publishers is less than a specified amount, accepting, from a second sponsor and by one or more computing devices, the lesser winning bid from among the second plurality of bids, the lesser winning bid being valued at a price that is less than a combination of the reserve price plus the margin, wherein accepting the lesser winning bid includes:
(i) deducting an amount associated with a deficiency of the lesser winning bid from the surplus account; and
(ii) providing content of the second sponsor for presentation in the given slot in response to accepting the lesser winning bid; and
when an amount in the surplus account is insufficient to subsidize the lesser winning bid or the subsidization history of the second content sponsor indicates that the subsidization value provided to the second sponsor by multiple publishers is greater than the specified amount, not accepting, from the second sponsor, the lesser winning bid, wherein not accepting the lesser winning bid includes not providing the content of the second sponsor for presentation in the given slot.
